(19) United States
(12) Patent Application Publication
(10) Pub. No.: US 2026/0131429 A1
(43) Pub. Date: May 14, 2026

(54) FIXING DEVICE FOR A FASTENING DEVICE FOR FIXING A STORAGE BODY TO A STORAGE SURFACE OF A STORAGE DEVICE

(71) Applicant: Schwäbische Werkzeugmaschinen GmbH, Schramberg-Waldmössingen (DE)

(72) Inventors: Thomas FONTAINE, Niedereschach (DE); Damian MARMOL, Chelmiec (PL); Jianjun GAO, Suzhou (CN)

(21) Appl. No.: 19/385,595

(22) Filed: Nov. 11, 2025

(30) Foreign Application Priority Data
Nov. 12, 2024 (EP) 24212266.1

(51) Int. Cl. B25B 5/12; B25B 5/02

(52) U.S. Cl. CPC B25B 5/12; B25B 5/02

(57) ABSTRACT

A fixing device for fixing a storage body to a storage surface of a storage device, having a base that can be fixed to the storage surface, a housing that surrounds or is fixed to the base, a clamping element that can be moved relative to the housing, and an actuating unit. The actuating unit including an actuating element, on which the clamping element is fixed in a rotationally fixed and stationary manner, and an actuator, by means of which the actuating element and the clamping element can be moved from a release position by rotation about a rotational axis extending transversely to the storage surface into a pre-clamping position, and by means of which the actuating element and clamping element can be moved from the pre-clamping position by translational movement parallel to the axis of rotation in the direction of the housing into a clamping position.

### CROSS-REFERENCE

This application claims the benefit of European application EP 24212266.1 filed November 12, 2024, which is incorporated herein by reference.

The invention relates to a fixing device for a fastening device for fixing a storage body to a storage surface of a storage device.

Fixing devices for a fastening device for fixing a storage body to a storage surface of a storage device are known from the state of the art in various designs. In this the fixing device is fixed to a storage surface of the storage device and a clamping element of the fixing device is arranged above a storage body and pulled tight using tools until the storage body to be clamped is clamped securely on the storage surface by the fixing device.

Depending on the accessibility of the position of the clamping element of the fixing device, which should fix the storage body by clamping, it is difficult for a tool to tighten the clamping element to get to the clamping element and the tightening of the clamping element with the tool proves to be awkward.

If the clamping element has already been fixed to the fixing device it can be difficult to arrange the fixing device on the storage surface if the geometry of the storage body to be fixed makes it more difficult to access the storage surface.

### SUMMARY

One task of an exemplary embodiment of the invention is to propose a fixing device for a fastening device for fixing a storage body to a storage surface of a storage device, in which the arrangement of a storage body on a storage surface and the fixing of the storage body with the fixing device is improved.

This task is solved by a fixing device for a fastening device for fixing a storage body to a storage surface of a storage device, with at least one base that can be fixed directly or indirectly to the storage surface of the storage device, with at least one housing that surrounds the base or is fixed to the base, with at least one clamping element that is arranged outside the housing on a side of the housing facing away from the base and can be moved relative to the housing, and with at least one actuating unit, which comprises at least one actuating element, on which the clamping element is fixed in a rotatable and stationary manner relative to the actuating element, and which comprises at least one actuator, by means of which the actuating element and the clamping element fixed to it can be moved from a release position by rotation about a rotational axis extending transversely to the storage surface into a pre-clamping position in which the actuating element and the clamping element are rotated relative to the release position about the rotational axis and are fixed against further rotation about the rotational axis, and by means of which the actuating element and clamping element can be moved from the pre-clamping position by translational movement parallel to the axis of rotation in the direction of the housing into a clamping position in which the distance between the clamping element and the storage surface is reduced relative to the pre-clamping position.

Since the fixing device comprises an actuating unit in which the actuating element and the actuator interact in such a way that the actuating element and the clamping element fixed to it can be moved from the release position to a pre-clamping position by rotating about an axis of rotation transverse to the storage surface, the clamping element can be pre-mounted on the fixing device and, by means of the actuator, can be moved from the release position, in which the clamping element allows the storage body to be placed on the storage surface without collision, to the pre-clamping position, in which the clamping element is positioned above the storage body for clamping and fixing the storage body.

As the actuator on the clamping element can be transferred from the pre-clamping position in the direction of the housing into the clamping position through translational movement, the storage body can be easily clamped.

By providing an actuator, it is not absolutely necessary for the clamping element to be directly accessible by a tool. The actuator can be arranged at a position of the fixing device that is always collision-free and is easily accessible by a tool or an operator.

In the clamping position the distance between the clamping element and the storage surface is reduced relative to the pre-clamping position, which means that the clamping element is moved from its arrangement in the pre-clamping position towards the storage surface in order to reach the clamping position.

In embodiments of the fixing device it proves to be advantageous if the transfer of the actuating element from the release position to the pre-clamping position includes both rotation about the axis of rotation and translational movement parallel to the axis of rotation towards the housing and/or if the clamping element is arranged in the pre-clamping position in the direction parallel to the axis of rotation, aligned with the storage body.

If the transfer of the actuating element from the release position to the pre-clamping position includes both rotation about the axis of rotation and translational movement parallel to the axis of rotation towards the housing, a distance to the storage surface can be reduced already when transferring the actuating element from the release position to the pre-clamping position. If the clamping element is arranged in the pre-clamping position parallel to the axis of rotation, aligned with the storage body, then the transfer from the pre-clamping position to the clamping position can only take place through a translational movement parallel to the axis of rotation. This simplifies the kinematics when transferring from the pre-clamping position to the clamping position.

In order to easily guide and hold the actuating element when transferring it from the release position to the pre-clamping position and from the pre-clamping position to the clamping position, it is advantageous for the housing to comprise a housing cavity in which the actuating element is arranged at least in sections and the actuating element is in contact, in particular over a large area, with a rotationally symmetrical outer surface section relative to the axis of rotation on a rotationally symmetrical inner surface section of the housing relative to the axis of rotation, wherein the actuating element is rotatable relative to the axis of rotation and movable parallel to the axis of rotation relative to the housing.

In a further development of the latter embodiment it can be provided that the fixing device includes at least one guide unit that includes at least one groove-like receptacle in the inner surface section of the housing, with at least one guide rail formed by a recess on the outer surface section of the positioning element and at least one guide bolt that engages in the receptacle and guiding rail.

By means of the provision of a guide unit the transfer from the release position into the pre-clamping position and from the pre-clamping position into the clamping position can be carried out easily mechanically through structural conditions and design as kinematics.

In principle, the guide unit can be designed in any way, as long as it specifies the kinematics for the transfer from the release position to the pre-clamping position and from the pre-clamping position to the clamping position. This can be easily ensured if the guide rail comprises a first guide section that runs transversely or obliquely to the axis of rotation, which extends in particular parallel to the axis of rotation in the direction of the clamping element and which specifies the transfer of the actuating element from the release position to the pre-clamping position, and if the guide mechanism comprises a second guide section into which the first guide section opens and which runs parallel or obliquely to the axis of rotation, which blocks further rotation about the axis of rotation and which specifies the transfer of the actuating element from the pre-clamping position to the clamping position.

The first guide section in the guide rail can comprise a cross section that expands like a beak. This can run essentially parallel to the storage surface on a boundary running towards the storage surface and extend on the side of the first guide section facing away from the storage surface towards the clamping element. As the second guide section runs parallel or obliquely to the axis of rotation, a further turning of the clamping element about the axis of rotation is blocked by the second guide section and only a movement parallel to the axis of rotation is possible. This provides a simple mechanical, guided means of transferring from the release position to the pre-clamping position and from the pre-clamping position to the clamping position.

In order to connect the actuator indirectly with the clamping element easily it proves to be advantageous if the actuating element includes at least one rod or bar-like transmission element that is at least in sections arranged in the housing, that is connected to the actuating element in a rotationally fixed manner and that has a transmission area that includes an external thread section that runs around the axis of rotation, that is arranged on the side of the transmission element facing away from the clamping element and by which, during operation of the actuator, the actuating element can be moved at least parallel to the axis of rotation in order to transfer it from the release position to the pre-clamping position and/or from the pre-clamping position to the clamping position.

As the transmission element is connected to the actuating element in a rotationally fixed manner and connected to the actuator with a transmission area, the actuating element of the actuating unit is connected to the actuator in a simple manner.

The transmission element interacts with the actuator via its transmission area comprising a single external thread section. This at least allows movement of the transmission element parallel to the axis of rotation.

In a further development of the latter embodiment the transmission element can be moved by the actuator when transferring the actuating element and the clamping element that is fixed to it from the release position to the pre-clamping position, not only parallel to the axis of rotation but also rotated about the axis of rotation. When the pre-clamping position is reached, the guide unit prevents the actuating element and the transmission element connected to the actuating element in a rotationally fixed manner from rotating further, whereby the actuating element is prevented from further rotation during the transition from the pre-clamping position to the clamping position and performs only a translational movement parallel to the axis of rotation in the direction of the storage surface.

In principle, the actuator can be designed in any way as long as it interacts with the transmission area of the transmission element to adjust the actuator. The fixing device can be easily operated if the actuator has at least one worm gear, which has at least one rod-like worm element that can be rotated around a worm axis extending transversely or obliquely to the axis of rotation and which comprises an external thread section in a transmission range, and which has at least one worm wheel that meshes with the external thread section of the worm element and, in particular, meshes with an internal thread section that meshes with the external thread section of the transmission element of the actuator, and/or if the actuator comprises at least one control element comprising a receptacle, which can be actuated from the outside and by means of which the worm element can be rotated about the worm axis when actuated.

As the actuator includes a worm gear, the control element can be easily positioned at any point on the fixing device so that it can be operated externally using a tool and/or by an operator. This means that when the clamping element is moved from the release position to the pre-clamping position and from the pre-clamping position to the clamping position, the clamping element must not be accessible.

In order to ensure relative movement of the transmission element to the worm gear and thus to perform the above-mentioned kinematics, it proves advantageous if the worm gear, in particular the worm element and the worm wheel, and/or the control element are arranged in the housing and fixed against translational movement parallel and transverse to the axis of rotation.

This ensures that when the worm gear is in operation, the transmission element inside the housing moves relative to the housing, wherein the worm gear and the control element remain essentially stationary.

Embodiments of the fixing device are conceivable in which the transmission element and the actuating element form a joint, single piece component or in which the transmission element and the actuating element comprise two components that are separate or can be separated that are connected to one another in a rotationally fixed manner with regard to the axis of rotation.

If the transmission element and the actuating element form a mutual, single part component, then the fixing device can be designed with fewer components. In this case the transmission area is formed on a side of the actuating element that faces the storage surface. If the transmission element and the actuating element comprise two components that are separate or that can be separated, then further, additional functions of the fixing device can be realised. If the transmission element and the actuating element comprise two components that are separate or that can be separated, it proves to be advantageous if the actuating unit comprises at least one anti-rotation device, through which the transmission element is fixed against twisting around the axis of rotation.

The provision of an anti-rotation device can ensure that the transmission element moves almost exclusively parallel to the axis of rotation when driven by the actuator and is secured again rotation movement.

The anti-rotation device can be provided at any position on the fixing device. In one embodiment, the anti-rotation device comprises at least one continuous recess in the actuating element extending transversely to the axis of rotation, at least one recess extending transversely to the axis of rotation and open on one side, at least one continuous hole extending transversely to the axis of rotation in the transmission element, and at least one pin-like cone element, which engages through the at least one recess in the actuating element and the at least one hole in the transmission element transversely to the axis of rotation and which in particular has a cross-section that is corresponding, in particular complementary to the cross-section of the at least one recess of the actuating element and which extends correspondingly, in particular complementarily, to an inner diameter of the hole of the transmission element extending transversely to the axis of rotation.

In this way the transmission element and the actuator element can be connected to one another easily. When the transmission element is fixed to the actuating element in a rotationally fixed manner, they are initially positioned relative to each other so that they are aligned transversely to the direction of rotation with at least one continuous recess and the continuous hole. In this case the cone element is inserted both through the at least one recess and the continuous hole in the transmission element.

The recess, which extends transversely to the axis of rotation and is open on one side, is also accessible from the direction of the cavity and/or opening.

In one embodiment of the fixing device the pin-like cone element extends in the enclosed arrangement in a level transverse to the axis of rotation as whole through the clamping element and the transmission element.

As the pin-like cone element has a cross-section that corresponds to, and in particular complements, the cross-section of at least one recess in the actuating element this prevents or at least severely restricts any relative movement of the cone element within the recess in the actuating element. The pin-like cone element can comprise a rounded, in particular circular or polygonal, in particular 4, 6 or 8-sided cross-section.

As described above, the anti-rotation device can be provided at any position on the fixing device. In a supplementary or alternative embodiment the anti-rotation device comprises at least one groove in the housing that extends parallel to the axis of rotation, in particular in the lower part of the housing that is arranged on a side facing away from the actuator element in relation to the actuator, and that comprises at least one pin-like cone element, which is detachably or non-detachably fixable or fixed at the free end of the transmission element facing away from the actuator element, which protrudes laterally from the transmission element transversely to the axis of rotation and engages with at least one end in at least one of the at least one groove.

In relation to the actuator, the groove can be arranged on a side of the housing facing the base. The same is true for the cone element, which is arranged on a side of the transmission element facing the base. The cone element can comprise a cross-section transverse to the axis of rotation, which is designed correspondingly, in particular complementarily, to the cross-section of the groove. The pin element engages in the groove, preventing the transmission element from rotating around the axis of rotation but allowing it to move parallel to the axis of rotation.

Embodiments are conceivable in which two grooves are provided in the housing, which are opposite each other with respect to the axis of rotation, wherein the pin element protrudes beyond the transmission element transversely to the axis of rotation on two sides and engages with each end in one groove each.

The fixing device can comprise at least one stop in the housing that limits a movement of the clamping element parallel to the axis of rotation when the clamping position is reached in the direction of the storage surface, wherein the actuator element, the transmission element and/or the clamping element is in contact with at least one of the at least one stop when in the clamping position. Furthermore, the fixing device can comprise at least one clamping element that acts between the transmission element and the actuator element and that clamps the clamping element fixed to the actuating element parallel to the axis of rotation in the direction of the housing.

If the fixing device comprises at least one stop, then the transfer from the pre-clamping position to the clamping position can be limited by the stop. If a clamping element is provided between the actuating element and the transmission element, which clamps the clamping element fixed to the actuating element parallel to the axis of rotation in the direction of the housing, the force acting on a storage body to be clamped is less rigid. In this case it is possible to slide the storage body slightly by overcoming the clamping force of the clamping element.

In order to allow relative movement parallel to the axis of rotation between the actuator element and the transmission element, which are fixed to one another in a rotationally fixed manner, it proves to be advantageous if the continuous hole in the transmission element that is transverse to the axis of rotation includes a slotted hole that extends parallel to the axis of rotation, through the transmission element parallel to the axis of rotation relative to the pin-like cone element between a first end position, in which the actuator element has an initial distance to the storage surface because of the clamping element, and a second end position, in which the actuator element has a second distance to the storage surface through movement against the clamping force of the clamping element and this is greater than the first distance.

The fixing device can be designed compactly if the actuator element on the actuator unit includes a cavity that is accessible at least from the direction of the base via an opening, wherein the bar or rod-like transmission element is arranged at least in part in the cavity of the actuator element.

In this case, the bar or rod-like transmission element can be arranged at least in sections within the actuator element.

In a further development of the latter embodiment it proves to be advantageous if the actuator element includes at least one coupling section that is arranged on the side of the actuator element facing away from the clamping element, that includes the opening to the cavity in the actuator element and that includes an interior diameter relative to the axis of rotation that is smaller than the interior diameter of the cavity, in particular wherein the coupling section of the actuator element comprises the continuous recess in the anti-rotation device, at least on one side, particularly on both sides relative to the axis of rotation.

Finally it proves to be advantageous if the actuator unit comprises at least one support element that is arranged in the cavity of the actuator element, that is fixed on the end of the transmission element that is opposite the actuator and that comprises an external diameter transverse to the axis of rotation that is corresponding, in particular complementary to the internal diameter of the cavity, and if the clamping element on the clamping unit is arranged in the cavity of the actuator element, is gripped through the transmission element parallel to the axis of rotation and is supported in contact with both the coupling section of the actuating element and the support element.

Viewed transversely to the axis of rotation, the clamping element comprises a diameter that is greater than the diameter of the coupling section of the actuator element that comprises the opening. Thus the clamping element is supported in contact both on the coupling section of the actuator element and on the support element that is fixed on the transmission element. In this case, relative movement of the actuating element relative to the transmission element reduces the distance between the coupling section and the support element, thereby compressing the clamping element. During this relative movement, the pin-like cone element moves from the first stop position in the slotted hole to the second end position.

Further features, details and advantages of the invention are apparent from the appended patent claims, from the drawing and from the following description of a preferred embodiment of the fixing device.

### BRIEF DESCRIPTION OF THE DRAWINGS

The drawing shows:

FIG. 1 A sectional view of a first exemplary embodiment of the fixing device in a release position of the actuating element and clamping element;

FIG. 2 A sectional view of the fixing device according to FIG. 1 in the pre-clamping position of the actuating element and clamping element;

FIG. 3 A sectional view of the fixing device according to FIG. 1 in the clamping position of the actuating element and clamping element;

FIG. 4 A detailed perspective view of the actuating element of the fixing device according to FIG. 1 in the release position, in the pre-clamping position and in the clamping position;

FIG. 5 A perspective view of the fixing device according to FIG. 1 with cutaway detail views of an actuator of the fixing device;

FIG. 6 A sectional view of a second exemplary embodiment of the fixing device in the area of an anti-rotation device.

### DETAILED DESCRIPTION

The figures show two exemplary embodiments of a fixing device marked as a whole with reference number 2 for a fastening device for fixing a storage body on a storage surface 4 of a storage device. The fixing devices 2 each comprise a base 6 that is directly or indirectly fixed on the storage surface 4 of the storage device.

Furthermore the fixing devices 2 each comprise a housing 8 that is fixed to the base 6. In the exemplary embodiments of the fixing device 2 shown in the figures, the housing 8 comprises a lower housing section 10 that is fixed to the base 6 and an upper housing section 12 that is fixed on the lower housing section 10.

The fixing devices 2 also comprise a clamping element 14 that is arranged on the side of the housing 8 outside the housing 8 facing away from the base 6 and moveable relative to the housing 8.

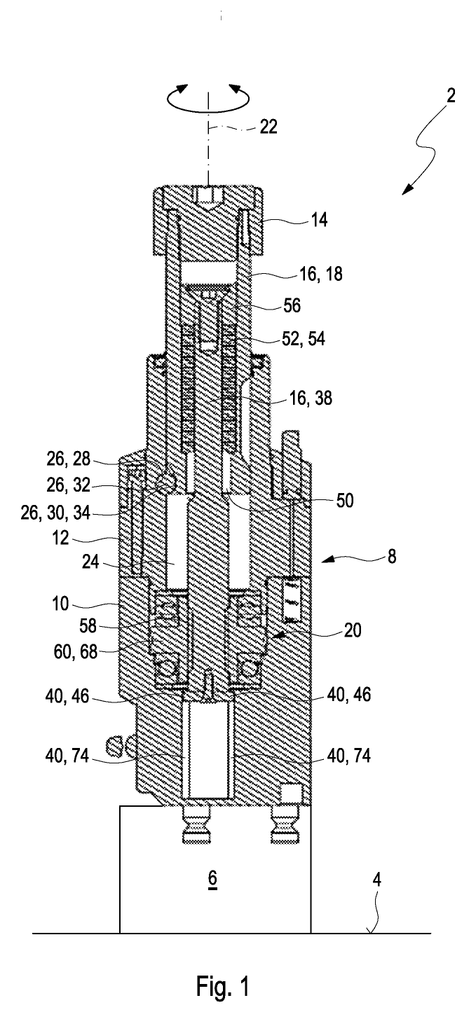

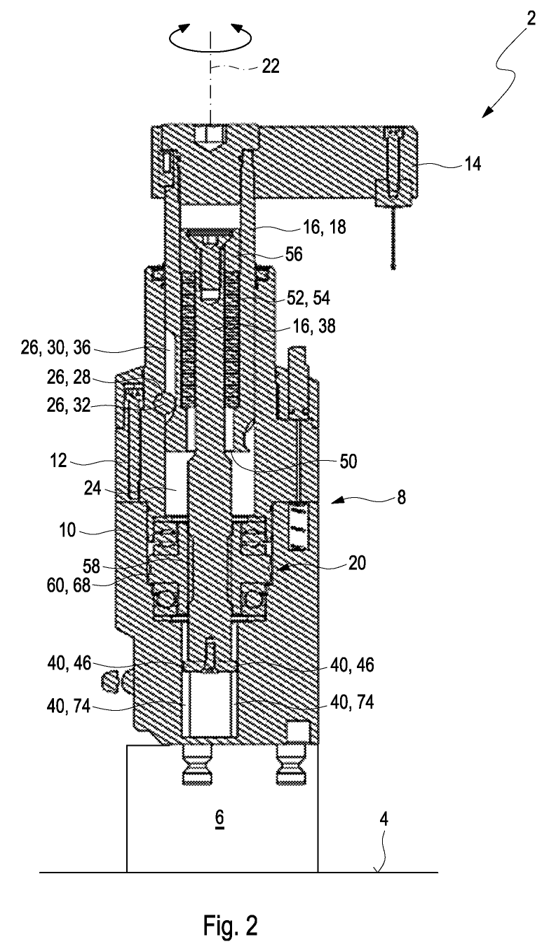

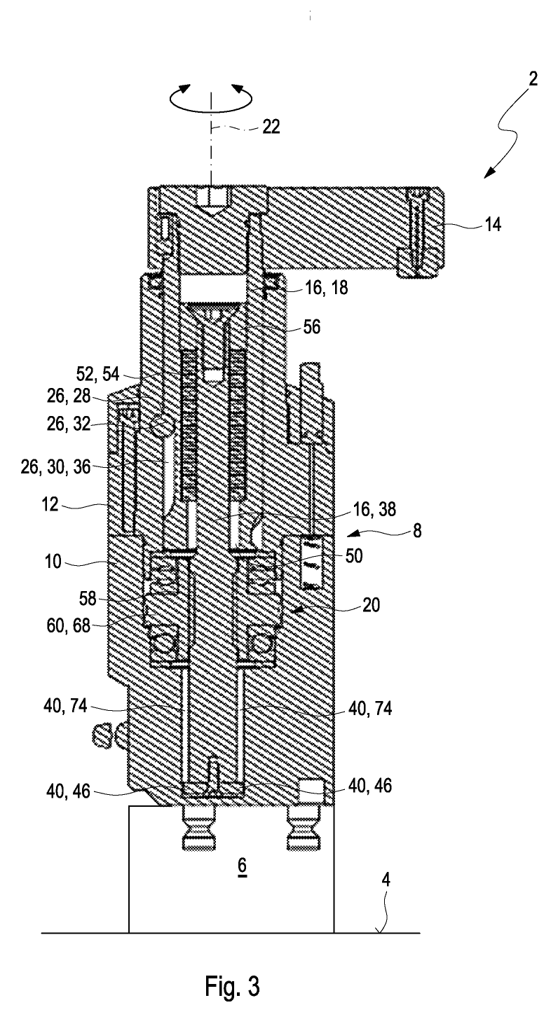

Furthermore, the fixing devices 2 comprise an actuating unit 16, which has an actuating element 18, on which the clamping element 14 is fixed in a rotationally fixed and stationary manner relative to the actuating element 18, and which comprises at least one actuator 20, by means of which the actuating element 18 and the clamping element 14 fixed to it can be transferred from a release position (FIG. 1) by rotating about a rotational axis 22 extending transversely to the storage surface 4 into a pre-clamping position (FIG. 2), in which the actuator element 18 and clamping element 14 are rotated relative to the release position with respect to the axis of rotation 22 and are fixed against further rotation about the axis of rotation 22 and can be transferred by the actuator element 18 and the clamping element 14 from the pre-clamping position (FIG. 2) by translational movement parallel to the axis of rotation 22 towards the housing 8 into a clamping position (FIG. 3), in which the distance between the clamping element 14 and the storage surface 4 is reduced relative to the pre-clamping position.

In the exemplary embodiments of the fixing device 2 shown in the figures, the housing 8 comprises a housing cavity 24 in which the actuating element 18 is arranged at least in sections, and the actuating element 18 with an outer surface section that is rotationally symmetrical with respect to the axis of rotation 22 rests flat against an inner surface section of the housing 8 that is rotationally symmetrical with respect to the axis of rotation 22, wherein the actuating element 18 is rotatable about the axis of rotation 22 and movable parallel to the axis of rotation 22 relative to the housing 8.

In order to transfer the actuator element 18 and the clamping element 14 fixed to it from the release position into the clamping position, a guide unit 26 is formed in the housing 8 and on the actuator element 18. This comprises a groove-like receptacle 28 in the inner surface section of the housing 8, a recess 30 on the outer surface section of the actuator element 18 and a guide bolt 32 that engages in receptacle 28 and in a guide rail 30 comprising a recess.

In the embodiments shown in the Figures the guide rail 30 that comprises the receptacle 28 is formed by a first guide section 34 that runs transversely to the axis of rotation 22, that expands in particular parallel to the axis of rotation 22 in the direction of the clamping element 14 and that specifies the transfer of the actuator element 18 from the release position into the pre-clamping position.

Furthermore, the guide rail 30 formed by the recess comprises a second guide section 36, into which the first guide section 34 opens, and that runs parallel or obliquely to the axis of rotation 22, which blocks further rotation around the axis of rotation 22 and that specifies the transfer of the actuator element 18 from the pre-clamping position into the clamping position.

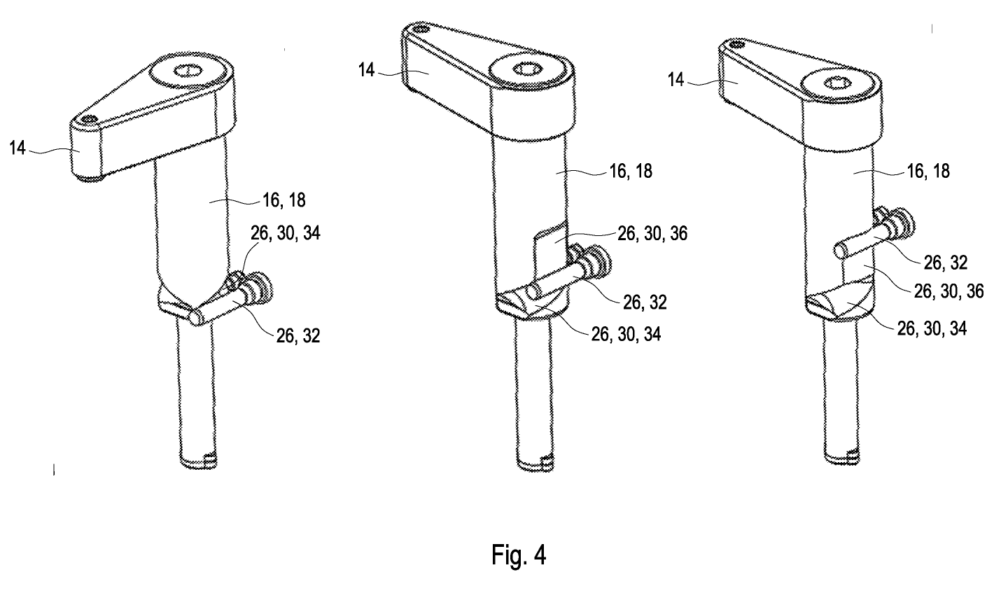

FIGS. 1 to 5 show an exemplary embodiment of the fixing device 2, in which the actuator unit 16 comprises a bar or rod-like transmission element 38. The transmission element 38 is arranged at least in sections in the housing 8. The transmission element 38 and actuator element 18 are connected to one another in a rotationally fixed manner via an anti-rotation device 40.

The anti-rotation device 40 comprises at least one groove 74 in the housing 8 that extends parallel to the axis of rotation, in particular in the lower part of the housing 10 that is arranged on a side facing away from the actuator element 18 in relation to the actuator 20, and that comprises at least one pin-like cone element 46, which is detachably or non-detachably fixable or fixed at the free end of the transmission element 38 facing away from the actuator element 18, which protrudes laterally from the transmission element 38 transversely to the axis of rotation 22 and engages with at least one end in at least one of the at least one groove 74.

In the first exemplary embodiment of the fixing device according to FIGS. 1 to 5, the groove 74 is arranged on a side of the housing 8 facing the base 6 with respect to the actuator 20. The same is true for the cone element 46, which is arranged on a side of the transmission element 38 facing the base 6.

The cone element 46 comprises a cross-section transverse to the axis of rotation 22, which is designed correspondingly, in particular complementarily, to the cross-section of the groove 74. The engagement of the 46 cone element in the groove 74 prevents the transmission element 38 from rotating around the axis of rotation 22 but allows it to move parallel to the axis of rotation 22.

In the exemplary embodiments shown in FIGS. 1 to 5 two grooves 74 are provided in the housing 8, which are opposite each other with respect to the axis of rotation 22, wherein the cone element 46 protrudes beyond the transmission element 38 transversely to the axis of rotation 22 on two sides and engages with each end in one groove 74 each.

Furthermore, the transmission element 38 comprises a transmission area 58 with an outer thread section on the side facing away from the support element 56. The transmission area 58 can be controlled by the actuator 20, whereby the transmission element 38 can be rotated about the rotational axis 22 and also performs a translational movement parallel to the rotational axis 22 in the direction of the storage surface 4 when the actuator 20 is operated to move from the release position to the pre-clamping position. Once it arrives in the pre-clamping position the transmission element 38 can be moved by the actuator 20 through a purely translational movement parallel to the axis of rotation 22 towards the storage surface 4. This is due to the fact that the transmission element 38 is connected to the clamping element 14 in a rotationally fixed manner and the clamping element 14 is fixed in the pre-clamping position by the guide unit 26 against further rotation about the axis of rotation 22.

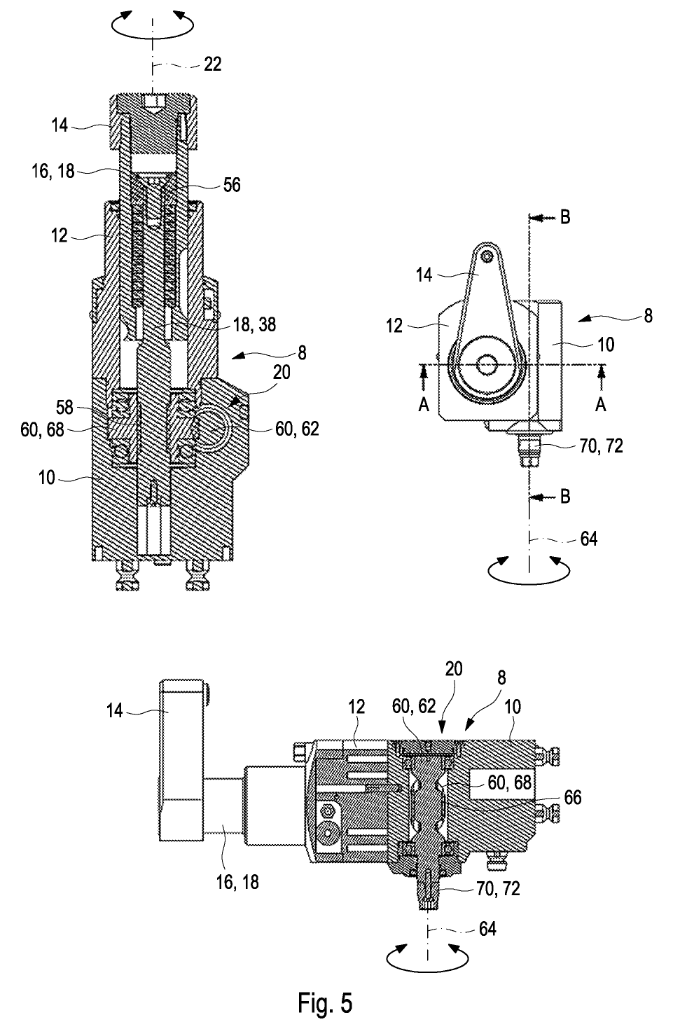

In the exemplary embodiment shown in the Figures, particularly in FIGS. 1 to 3 and in FIG. 5, it can be seen that the actuator 20 has a worm gear 60, which has at least one rod-like worm element 62 that can be rotated around a worm axis 64 extending transversely or obliquely to the axis of rotation 22 and which comprises an external thread section in a transmission area 66, which has at least one worm wheel 68 that has an external threaded section that engages with the external threaded section of the worm element 62 and an internal threaded section that engages with the external threaded section of the transmission element 36 of the actuator unit 16.

In addition, the actuator 20 comprises a control element 72 comprising a receptacle 70, which can be actuated from the outside and by means of which the worm element 62 can be rotated about the worm axis 64 when actuated.

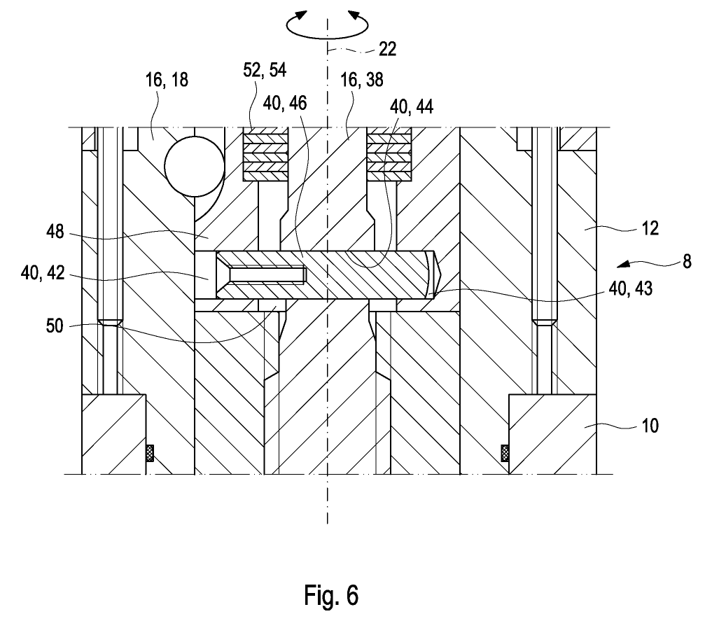

FIGS. 6 shows a detailed view of a second exemplary embodiment of the fixing device 2, in which the actuator unit 16 comprises a bar or rod-like transmission element 38. The transmission element 38 is arranged at least in sections in the housing 8. The transmission element 38 and actuator element 18 are connected to one another in a rotationally fixed manner via an anti-rotation device 40.

The anti-rotation device 40 comprises continuous recesses 42 in the actuating element 18 extending transversely to the axis of rotation 22, a recess 43 in the actuating element 18 open on one side, a continuous hole 44 extending transversely to the axis of rotation 22 in the transmission element 38, and a pin-like cone element 46 extending through both the recesses 42 and the hole 44.

In the exemplary embodiment of the fixing device 2 shown in the figure, the anti-rotation device 40 is arranged in a coupling section 48 of the actuating element 18. An opening 50 is provided in the coupling section 48, through which a cavity 52 of the actuating element 18 is accessible from the outside. A clamping element 54 is arranged in the cavity 52, which is arranged on one side at the coupling section 48 of the actuating element 18. On the side opposite coupling section 48, a support element 56 of the actuating unit 16 is provided, which is fixed to the transmission element 38 on the side opposite the actuator 20.

The hole 44 in the transmission element 38 comprised a slotted hole in which the pin-like cone element 46 is arranged in a first end position in the embodiment shown in the figures. In the first end position the actuator element 18 displays a first distance to the storage surface 4 due to the clamping element 54. The actuator element 18 can be moved away from the storage surface 4 in a direction parallel to the axis of rotation 22 by overcoming the clamping force until the pin-like cone element 46 can be arranged in a second end position (not shown in the figures), in which the actuator element 18 is at a second distance, which is greater than the first distance.

In the following, the mode of operation of the fixing device 2 is described in brief:

When the control element 72 is actuated, for example with a tool or manually, the worm element 62 is rotated about the worm axis 64, which runs transversely to the axis of rotation 22. The worm wheel 68 is driven to rotation about the axis of rotation 22 via the external thread section in the transmission area 66 of the worm element 62. In this case, the transmission element 38 that is arranged with its external thread section in the transmission area 58 in the inner thread section of the worm wheel 68 rotates about the axis of rotation 22. Here, the transmission element 38 is connected in a rotationally fixed manner to the actuator element 18, which thus also rotates about the axis of rotation 22 from the release position according to FIG. 1. With the rotation about the axis of rotation 22, the clamping element 14 rotates relative to the housing 8, moving the guide bolt 32 along the first guide section 34 of the guide unit 26.

Once the pre-clamping position according to FIG. 1 is reached, the guide bolt 32 reaches the second guide section 36 of the guide unit 26, which fixes the actuator element 18 and the transmission element 38 that is connected to the actuator element 18 in a rotationally fixed manner against further rotation about the axis of rotation 22. After the pre-clamping position in FIG. 2 is reached, the transmission element 38 can only be moved parallel to the axis of rotation 22 during further operation of the actuator 20, whereby the distance of the clamping element 14 relative to the storage surface 4 is reduced. When the clamping position is reached according to FIG. 3, clamping element 14, actuator element 18 and/or transmission element 38 are in contact with an end stop on housing 8, which limits further movement parallel to the axis of rotation 22 towards the storage surface 4.

In order to release the clamping element 14 slightly to move and align the storage body, the actuator element 18 can be moved away from the storage surface 4 against the clamping force of the clamping element 54, wherein the pin-like cone element 46 is moved within the slotted hole 44 relative to the transmission element 38.

The features of the invention disclosed in the above description, in the claims and in the drawing may be essential for the realisation of the invention in its various embodiments, both individually and in any combination, within the scope of the following claims.

### REFERENCE SYMBOL LIST

2 Fixing device

4 Storage surface

6 Base

8 Housing

10 Lower housing section

12 Upper housing section

14 Clamping element

16 Actuator unit

18 Actuator element

20 Actuator

22 Axis of rotation

24 Housing cavity

26 Guide unit

28 Groove-like receptacle

30 Guide rail

32 Guide bolts

34 First guide section

36 Second guide section

38 Transmission element

40 Anti-rotation device

42 Continuous recess

43 Recess open on one side

44 Continuous hole

46 Cone element

48 Coupling section

50 Opening

52 Cavity

54 Clamping element

56 Support element

58 Transmission area

60 Worm gears

62 Worm element

64 Worm axis

66 Transmission area

68 Worm wheel

70 Receptacle

72 Control element

74 Groove

1. A fixing device for a fastening device for fixing a storage body to a storage surface of a storage device, comprising:
at least one base that can be fixed directly or indirectly to the storage surface of the storage device,
at least one housing that surrounds the base or is fixed to the base,
at least one clamping element that is arranged outside the housing on a side of the housing facing away from the base and can be moved relative to the housing, and
at least one actuating unit, which comprises at least one actuating element, on which the clamping element is fixed in a rotationally fixed and stationary manner relative to the actuating element, and which comprises at least one actuator, by means of which the actuating element and the clamping element fixed to it can be moved from a release position by rotation about a rotational axis extending transversely to the storage surface into a pre-clamping position in which the actuating element and the clamping element are rotated relative to the release position about the rotational axis and are fixed against further rotation about the rotational axis, and by means of which the actuating element and clamping element can be moved from the pre-clamping position by translational movement parallel to the rotational axis in the direction of the housing into a clamping position in which the distance between the clamping element and the storage surface is reduced relative to the pre-clamping position.

2. The fixing device according to claim 1, wherein the transfer of the actuating element from the release position to the pre-clamping position includes both rotation about the rotational axis and translational movement parallel to the rotational axis towards the housing and/or if the clamping element is arranged in the pre-clamping position in the direction parallel to the rotational axis, aligned with the storage body.

3. The fixing device according to claim 1, wherein the housing comprises a housing cavity in which the actuating element is arranged at least in sections, and the actuating element with an outer surface section that is rotationally symmetrical with respect to the rotational axis rests flat against an inner surface section of the housing that is rotationally symmetrical with respect to the rotational axis, wherein the actuating element is rotatable about the rotational axis and movable parallel to the rotational axis relative to the housing.

4. The fixing device according to claim 3, wherein at least one guide unit that includes at least one groove-like receptacle in the inner surface section of the housing, at least one guide rail formed by a recess on the outer surface section of the actuator element and at least one guide bolt that engages in the receptacle and guiding rail.

5. The fixing device according to claim 4, wherein the guide rail comprises a first guide section that runs transversely or obliquely to the rotational axis, which extends parallel to the rotational axis in the direction of the clamping element and which specifies the transfer of the actuating element from the release position to the pre-clamping position, and that the guide rail comprises a second guide section into which the first guide section opens and which runs parallel or obliquely to the rotational axis, which blocks further rotation about the rotational axis and which specifies the transfer of the actuating element from the pre-clamping position to the clamping position.

6. The fixing device according to claim 1, wherein the actuator unit includes at least one rod or bar-like transmission element that is at least in sections arranged in the housing, that is connected to the actuating element in a rotationally fixed manner and that has a transmission area that includes an external thread section that runs around the rotational axis, that is arranged on the side of the transmission element facing away from the clamping element and by which, during operation of the actuator, the actuating element can be moved at least parallel to the rotational axis in order to transfer it from the release position to the pre-clamping position and/or from the pre-clamping position to the clamping position.

7. The fixing device according to claim 1, wherein the actuator has at least one worm gear, which has at least one rod-like worm element that can be rotated around a worm axis extending transversely or obliquely to the rotational axis and which comprises an external thread section in a transmission area, and which has at least one worm wheel that meshes with the external thread section of the worm element and meshes with an internal thread section that meshes with the external thread section of the transmission element of the actuator unit, and/or if the actuator comprises at least one control element comprising a receptacle, which can be actuated from the outside and by means of which the worm element can be rotated about the worm axis when actuated.

8. The fixing device according to claim 7, wherein the worm gear, and/or that the control element is arranged in the housing and is fixed against translational movement parallel and transverse to the rotational axis.

9. The fixing device according to claim 6, wherein the transmission element and the actuating element form a joint, single piece component or that the transmission element and the actuating element comprise two components that are separate or can be separated that are connected to one another in a rotationally fixed manner with regard to the rotational axis.

10. The fixing device according to claim 6, wherein the actuator unit comprises at least one anti-rotation device, with which the transmission element is fixed against rotating about the rotational axis.

11. The fixing device according to claim 10, wherein the anti-rotation device comprises at least one continuous recess in the actuating element extending transversely to the rotational axis, at least one recess in the actuator element extending transversely to the rotational axis and open on one side, at least one continuous hole extending transversely to the rotational axis in the transmission element, and at least one pin-like cone element, which engages through the at least one recess in the actuating element and the at least one hole in the transmission element transversely to the rotational axis and which has a cross-section that is correspondingly complementary to the cross-section of the at least one recess of the actuating element and which extends correspondingly to an inner diameter of the hole of the transmission element extending transversely to the rotational axis.

12. The fixing device according to claim 10, wherein the anti-rotation device comprises at least one groove in the housing that extends parallel to the rotational axis and that comprises at least one pin-like cone element, which is detachably or non-detachably fixable or fixed at the free end of the transmission element facing away from the actuator element, which protrudes laterally from the transmission element transversely to the rotational axis and engages with at least one end in at least one of the at least one groove.

13. The fixing device according to claim 1, wherein at least one stop in the housing, which limits movement of the clamping element parallel to the rotational axis when the clamping position is reached in the direction of the storage surface, wherein, in the clamping position, the actuator element, the transmission element and/or the clamping element rests against at least one of the at least one stop, and/or by at least one clamping element which acts between the transmission element and the actuator element and which clamps the clamping element fixed to the actuator element parallel to the rotational axis in the direction of the housing.

14. The fixing device according to claim 12, wherein the hole extending transversely to the rotational axis in the transmission element comprises a slotted hole extending parallel to the rotational axis, through which the transmission element can be moved parallel to the rotational axis relative to the pin-like cone element between a first stop position, in which the actuating element has a first distance to the storage surface due to the clamping element, and a second stop position, in which the actuating element has a second distance to the storage surface due to movement against the tensioning force of the clamping element, whereby the second distance is greater than the first distance.

15. The fixing device according to claim 6, wherein the actuator element on the actuator unit includes a cavity that is accessible at least from the direction of the base via an opening, wherein the bar or rod-like transmission element is arranged at least in part in the cavity of the actuator element.

16. The fixing device according to claim 15, wherein the actuator element includes at least one coupling section that is arranged on the side of the actuator element facing away from the clamping element, which includes the opening to the cavity in the actuator element and that includes an interior diameter relative to the rotational axis that is smaller than the interior diameter of the cavity.

17. The fixing device according to claim 15, wherein the actuator unit comprises at least one support element that is arranged in the cavity of the actuator element, which is fixed on the end of the transmission element that is opposite the actuator and that comprises an external diameter transverse to the rotational axis that is corresponding to the internal diameter of the cavity, and if the clamping element on the actuator unit is arranged in the cavity of the actuator element, is gripped through the transmission element parallel to the rotational axis and is supported in contact with both the coupling section of the actuating element and the support element.
